(19) United States
(12) Patent Application Publication
(10) Pub. No.: US 2007/0070029 A1
(43) Pub. Date: Mar. 29, 2007

(54) Method and apparatus for improving brightness in an electrophoretic display

(76) Inventors: Mark Thomas Johnson, Eindhoven (NL); Alexander Victor Henzen, Heerlen (NL); Guofu Zhou, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/579,313

(22) PCT Filed: Nov. 11, 2004
(86) PCT No.: PCT/IB04/52379

§ 371 Date: May 16, 2006

(30) Foreign Application Priority Data
Nov. 21, 2003 (EP) 03104308.6

(51) Int. Cl. G09G 3/34

(52) U.S. Cl. 345/107

(57) ABSTRACT

An electrophoretic display (1) comprising an electrophoretic medium (5) comprising a plurality of negatively charged black particles (6) and a plurality of positively charged white particles (6) in fluid. The average dc value of the drive voltages is arranged to be non-zero, so as to maximise brightness or contrast ratio of the displayed image, as required. If the average dc value of the drive voltages has a positive polarity, such that a small positive voltage is applied to the pixel electrode (3), although the white level may be less bright, the black level becomes darker, thereby increasing the contrast ratio during the driving sequence, which is obviously advantageous if the contrast ratio is the most important display parameter. If, on the other hand, maintaining or increasing a maximum brightness level is of key importance, then a drive sequence where the average dc value of all drive waveforms has a negative polarity is applied, so as to apply a small, controlled negative voltage to the pixel electrode (3). In this case, although the black level may become less dark, the white level becomes significantly brighter, such that the brightness is increased during the driving sequence, which is obviously advantageous if brightness is the most important display parameter.

This invention relates generally to electrophoretic displays in which tiny coloured particles move in a fluid between electrodes, and more particularly to a method and apparatus for improving brightness in an electrophoretic display.

An electrophoretic display comprises an electrophoretic medium consisting of charged particles in a fluid, a plurality of picture elements (pixels) arranged in a matrix, first and second electrodes associated with each pixel, and a voltage driver for applying a potential difference to the electrodes of each pixel to cause it to occupy a position between the electrodes, depending on the value and duration of the applied potential difference, so as to display a picture.

In more detail, an electrophoretic display device is a matrix display with a matrix of pixels which are associated with intersections of crossing data electrodes and select electrodes. A grey level, or level of colourisation of a pixel depends on the time a drive voltage of a particular level is present across the pixel. Dependent on the polarity of the drive voltage, the optical state of the pixel changes from its present optical state continuously towards one of two limit situations or extreme optical state brightnesses, i.e. one type of all charged particles is near the bottom of the pixel or near the top of the pixel.

Usually, all of the pixels of the matrix display are selected line-by-line by supplying appropriate voltages to the select electrodes. The data is supplied in parallel via the data electrodes to the pixels associated with the selected line. If the display is an active matrix display, the select electrodes with active elements TFT's, MIM's, diodes, which in turn allow data to be supplied to the pixel. The time required to select all of the pixels of the matrix display once is called the sub-frame period. A particular pixel either receives a positive drive voltage, a negative drive voltage or a zero drive voltage during the whole sub-frame period, depending on the change in optical state required to be effected. A zero drive voltage is usually applied to the pixel if no change in optical state is required to be effected.

In a display using an electrophoretic foil, many insulating layers are present between the ITO-electrodes, which layers become charged as a result of the applied potential differences. The charge present at the insulating layers is determined by the charge initially present at the insulating layers and the subsequent history of the potential differences. Therefore, the positions of the particles depend not only on the potential differences being applied, but also on the history of the potential differences.

As stated above, levels of colourisation of the pixels, or grey levels, in electrophoretic displays are generally created by applying voltage pulses for specified time periods. They are strongly influenced by image history, dwell time, temperature, humidity, lateral inhomogeneity of the electrophoretic foils, etc. In order to consider the complete history, driving schemes based on the transition matrix have been proposed. In such an arrangement, a matrix look-up table (LUT) is required, in which driving signals for a greyscale transition with different image history are predetermined. However, build-up of remnant dc voltages after a pixel is driven from one grey level to another is unavoidable because the choice of the driving voltage level is generally based on the requirement for the grey value. This build-up of remnant or residual dc voltages influences the positions of the particles, and forces them closer to or further away from the electrodes, depending on the polarity. Thus, the remnant dc voltages, especially after integration after multiple greyscale transitions, tend to result in a change in the extreme optical state brightnesses (i.e. black and white)—in general, they both may become more grey—which in turn results in a reduction of both brightness and contrast ratio of the display. Even in the case DC=0, both states become more grey due to particle diffusion.

Known methods of reducing the effects of the above-described build-up of residual dc voltages use reset pulses supplied to all pixels (between picture voltages). The reset pulses are of the same polarity value as the preceding picture voltage, but of a shorter time duration, and cause the image displayed to become completely white or black after each sub-frame period. Consequently, these reset pulses seriously diminish display performance because the display flashes between black and white.

Non pre-published European patent application 03100575.4 describes an arrangement in which the reset pulses applied to each pixel between pixel voltages are of an opposite polarity to the preceding picture voltage, which reduces the undesired charge accumulation in the pixel, and causes at least part of the charging of the insulators due to the picture voltage to be undone. Therefore, the display panel is subsequently able to display pictures of at least relatively medium quality.

Non pre-published European patent application 02079282.6 describes an alternative arrangement, in which a DC-balancing circuit is provided to overcome the above-mentioned problems. The DC-balancing circuit includes a controller for determining, in respect of each pixel or relatively small sub-group of pixels, a time-average (of picture voltage) applied thereto, and for adapting the value and/or duration of the picture voltage applied to the respective pixel (or sub-group of pixels) to obtain a time-average value of around zero. This control of the amplitude of the drive voltages and/or the duration of the drive pulses, causes the effects of the above-mentioned residual dc voltage to be reduced, without the need for reset pulses in respect of all of the pixels, and therefore with less disturbing visual effects than in the above-mentioned prior art method.

It is an object of the present invention to provide a method and apparatus for enabling the brightness or contrast ratio of a displayed image to be increased.

In accordance with the present invention, there is provided a display apparatus comprising:
An electrophoretic medium comprising charged particles in a fluid;
A plurality of picture elements;
A first and second electrode associated with each picture element for receiving a potential difference; and
Drive means arranged to supply a sequence of picture potential differences to each of said picture elements so as to cause said charged particles to move and change the optical state of a respective picture element substantially continuously between two extreme grey scales according to an image to be displayed, wherein said picture potential differences have a non-zero average dc value, the polarity of which is selected to increase the level of brightness of one said extreme grey scales or to increase the contrast ratio of the image displayed by said apparatus.

Also in accordance with the present invention, there is provided a method of increasing brightness or contrast ratio in a display apparatus comprising:
An electrophoretic medium comprising charged particles in a fluid;
A plurality of picture elements;
A first and second electrode associated with each picture element for receiving a potential difference; and
Drive means arranged to supply a sequence of picture potential differences to each of said picture elements so as to cause said charged particles to move and change the optical state of a respective picture element substantially continuously between two extreme grey scales according to an image to be displayed;
   wherein the method comprises supplying picture potential differences which have a non-zero average dc value, the polarity of which is selected to increase the level of brightness one of said extreme grey scales or to increase the contrast ratio of the image displayed by said apparatus.

Drive means for driving a display apparatus comprising:
An electrophoretic medium comprising charged particles in a fluid;
A plurality of picture elements; and
A first and second electrode associated with each picture element for receiving a potential difference;
Drive means being arranged to supply a sequence of picture potential differences to each of said picture elements so as to cause said charged particles to move and change the optical state of a respective picture element substantially continuously between two extreme grey scales according to an image to be displayed, wherein said picture potential differences have a non-zero average DC value the polarity of which is selected to increase the level of brightness of one said extreme grey scales or to increase the contrast ratio of the image displayed by said apparatus.

A drive waveform for driving a display apparatus comprising:
An electrophoretic medium comprising charged particles in a fluid;
A plurality of picture elements;
A first and second electrode associated with each picture element for receiving a potential difference; and
Drive means arranged to supply said drive waveform to said apparatus, said drive waveform comprising a sequence of picture potential differences for application to each of said picture elements so as to cause said charged particles to move and change the optical state of a respective picture element substantially continuously between two extreme grey scales according to an image to be displayed, wherein said picture potential differences have a non-zero average DC value, the polarity of which is selected to increase the level of brightness of one of said extreme grey scales, or to increase the contrast ratio of the image displayed by said apparatus.

In one embodiment of the present invention, a plurality of charged particles are provided in said fluid, one or some of which are of a first colour, say black, and one or some of the remaining of which are of a second colour, say, white. The particles of said first colour are charged with a first polarity and the particles of said second colour are charged with a second, opposite polarity, such that application of a picture potential difference of the second polarity causes the particles of the first colour to move towards the top of the respective picture element, and causes the picture element to appear that colour. Similarly, application of a picture potential difference of the first polarity to a picture element, causes the particles of the second colour to move towards the top of that picture element, and causes the picture element to appear that colour.

Thus, consider the case where the particles of the first colour (say black) are negatively charged and the particles of the second colour (say white) are positively charged. In a first embodiment, the drive means is arranged to apply a drive sequence of picture potential differences, where the dc value of all of the drive waveforms (in one specific embodiment this may be 16) is non-zero and of a positive polarity, thereby applying a small positive voltage on the pixel electrode. Although the white level may be caused to appear less bright, the black level is caused to appear darker, thereby increasing the contrast ratio during the driving sequence. This is obviously advantageous if the contrast ratio is the most important display parameter.

On the other hand, however, in other situations, maintaining or increasing a maximum brightness level is of key importance. Thus, in a second embodiment, the drive means may be arranged to apply a drive sequence where the average dc value of all drive waveforms is negative, and thereby applies a controlled negative voltage on the pixel electrode. In this case, although the black level may appear less dark, the white level is caused to appear brighter, such that the brightness increases during the driving sequence. This is obviously advantageous if the brightness is the most important display parameter.

It will be appreciated that the above-mentioned effects are obtainable in a system having positively charged white particles and negatively charged black particles. If, however, the white particles are negatively charged and the black particles are positively charged, then a drive sequence having an average dc value which is negative will result in the above-described improvement in the contrast ratio, and a drive sequence having an average dc value which is positive will result in the above-described improvement in brightness.

The value of the average dc voltage component in the drive waveforms could be made variable, so to vary the trade-off between the level of brightness or contrast improvement and the corresponding reduction in contrast ratio or brightness, respectively, and/or to allow selection according to whether contrast ratio or brightness is the most important display parameter. This may be user-definable, by means of, for example, a contrast/brightness control mechanism.

The present invention is also applicable to apparatus having only one particle, wherein the liquid is coloured, such that the colour and polarity of the particle will determine the required dc voltage to be applied to the pixel electrode to achieve either a brightness improvement or a contrast improvement.

These and other aspects of the present invention will be apparent from, and elucidated with reference to, the embodiments described herein.

Embodiments of the present invention will now be described by way of examples only and with reference to the accompanying drawings, in which:

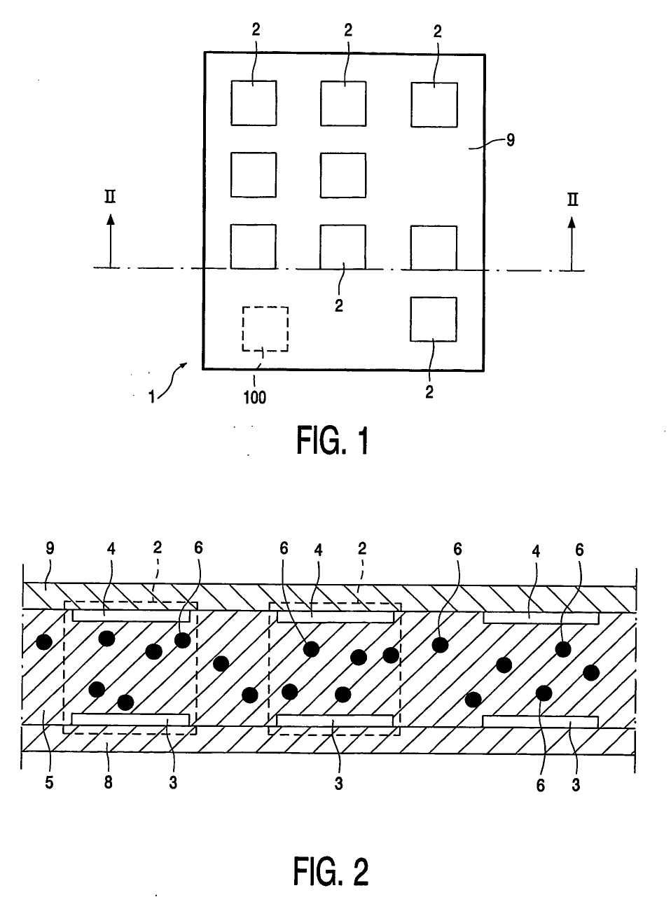

FIG. 1 is a schematic front view of a display panel according to an exemplary embodiment of the present invention;

FIG. 2 is a schematic cross-sectional view along II-II of FIG. 1; and

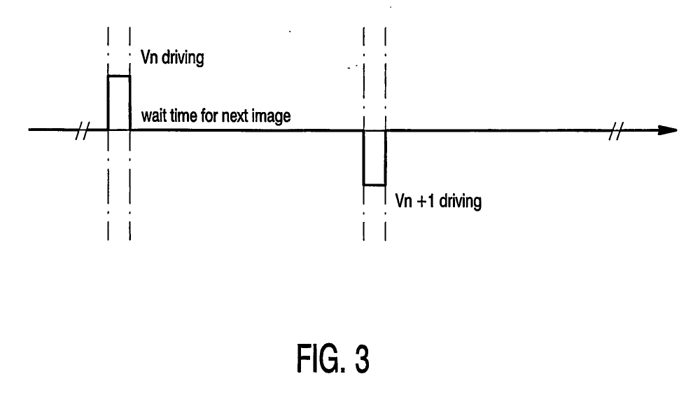

FIG. 3 illustrates part of a typical greyscale transition sequence using a voltage modulated transition matrix according to the prior art.

FIGS. 1 and 2 illustrate an exemplary embodiment of a display panel 1 having a first substrate 8, a second opposed substrate 9, and a plurality of picture elements 2. In one embodiment, the picture elements 2 might be arranged along substantially straight lines in a two-dimensional structure. In another embodiment, the picture elements 2 might be arranged in a honeycomb arrangement.

An electrophoretic medium 5, having charged particles 6 in a fluid, is present between the substrates 8, 9. A first and second electrode 3, 4 are associated with each picture element 2 for receiving a potential difference. In the arrangement illustrated in FIG. 2, the first substrate 8 has for each picture element 2 a first electrode 3, and the second substrate 9 has for each picture element 2 a second electrode 4. The charged particles 6 are able to occupy extreme positions near the electrodes 3, 4, and intermediate positions between the electrodes 3, 4. Each picture element 2 has an appearance determined by the position of the charged particles 6 between the electrodes 3, 4.

Electrophoretic media are known per se from, for example, U.S. Pat. No. 5,961,804, U.S. Pat. No. 6,120,839 and U.S. Pat. No. 6,130,774, and can be obtained from, for example, E Ink Corporation. As an example, the electrophoretic medium 5 might comprise negatively charged black particles 6 in a white fluid. When the charged particles 6 are in a first extreme position, i.e. near the first electrode 3, as a result of potential difference applied to the electrodes 3, 4 of, for example, 15 Volts, the appearance of the picture element 2 is for example, white in the case that the picture element 2 is observed from the side of the second substrate 9.

When the charged particles 6 are in a second extreme position, i.e. near the second electrode 4, as a result of a potential difference applied to the electrodes 3, 4 of, for example, −15 Volts, the appearance of the picture element is black. When the charged particles 6 are in one of the intermediate positions, i.e. between the electrodes 3, 4, the picture element 2 has one of a plurality of intermediate appearances, for example, light grey, mid-grey and dark grey, which are grey levels between black and white.

As explained above, after prolonged driving of an electrophoretic display, according to the prior art, the extreme optical state brightnesses (i.e. black and white in the arrangement described above) change. In general, they both tend to become more grey. As a result, both brightness and contrast ratio are reduced.

FIG. 3 illustrates part of a typical conventional random greyscale transition sequence using a voltage modulated transition matrix. Between the image state n and the image state n+1, there is always a certain time period available which may be anything from a few seconds to a few minutes, dependent on different users. When the display is driven to the image state n+1 from the state n, a pre-determined voltage Vₙ₊₁ is applied (available from the transition matrix look-up table). In the illustrated example, the driving pulse n has an opposite sign to the driving pulse n+1, which gives the minimum remnant dc voltages. Ideally, when the amplitude of both n and n+1 driving pulses is equal, this driving is then automatically dc balanced (since the pulse width is the same). As described above however, even this situation will result in brightness and contrast ratio reduction. However, the greyscale transitions in practical displays are completely random and thus the remnant dc voltages tend to appear on the pixel. If the DC voltages are added to the dada of the image, this may also result in image retention effects, which reduce the quality of image.

Thus, in accordance with the invention, a drive sequence is applied in which the average dc value of (say 16) drive waveforms is non-zero. In the electrophoretic display described above, if the average dc value has a positive polarity, such that a small positive voltage is applied to the pixel electrode, although the white level may be less bright, the black level becomes darker, thereby increasing the contrast ratio during the driving sequence, which is obviously advantageous if the contrast ratio is the most important display parameter.

If, on the other hand, maintaining or increasing a maximum brightness level is of key importance, then a drive sequence where the average dc value of all drive waveforms has a negative polarity is applied, so as to apply a small, controlled negative voltage to the pixel electrode. In this case, although the black level may become less dark, the white level becomes significantly brighter, such that the brightness is increased during the driving sequence, which is obviously advantageous if brightness is the most important display parameter.

Whether the most important display parameter is contrast ratio or brightness may be user defined, perhaps by means of a brightness/contrast button or the like. A controller would be provided to receive a data input from such a control mechanism and set the average dc value of the driving sequence according to user requirements. The additional dc value applied to the pixel electrode influences the position of the particles, forcing them closer to or further away from the electrodes, depending upon its polarity, as explained above.

Embodiments of the present invention have been described above by way of example only, and it will be apparent to a person skilled in the art that modifications and variations can be made to the described embodiments without departing from the scope of the invention as defined by the appended claims. Further, in the claims, any reference signs placed between parentheses shall not be construed as limiting the claim. The term “comprising” does not exclude the presence of elements or steps other than those listed in a claim. The terms “a” or “an” does not exclude a plurality. The invention can be implemented by means of hardware comprising several distinct elements, and by means of a suitably programmed computer. In a device claim enumerating several means, several of these means can be embodied by one and the same item of hardware. The mere fact that measures are recited in mutually different independent claims does not indicate that a combination of these measures cannot be used to advantage.

1. A display apparatus (1) comprising:
An electrophoretic medium (6) comprising charged particles (6) in a fluid;
A plurality of picture elements (2);
A first and second electrode (3,4) associated with each picture element (2) for receiving a potential difference; and
Drive means arranged to supply a sequence of picture potential differences to each of said picture elements (2) so as to cause said charged particles (6) to move and change the optical state of a respective picture element (2) substantially continuously between two extreme grey scales in accordance with an image to be displayed, wherein said picture potential differences have a non-zero average dc value, the polarity of which is selected to increase the level of brightness of one said extreme grey scales or to increase the contrast ratio of the image displayed by said apparatus.

2. Apparatus according to claim 1, comprising a plurality of charged particles (6) in said fluid, one or some of which are of a first colour and one or some of the remaining of which are of a second colour.

3. Apparatus according to claim 2, wherein the particles (6) of said first colour are charged with a first polarity and the particles (6) of said second colour are charged with a second, opposite polarity.

4. Apparatus according to claim 3, wherein application of picture potential differences having an average dc voltage of a polarity opposite to that of the particles (6) of said first colour causes an increase in the contrast ratio of an image displayed by the apparatus.

5. Apparatus according to claim 3, wherein application of picture potential differences having an average dc voltage of a polarity opposite to that of the particles (6) of said second colour causes an increase in the brightness of an image displayed by the apparatus.

6. Apparatus according to claim 4, wherein said first colour is substantially black and said second colour is substantially white.

7. Apparatus according to claim 1, wherein the polarity of the average dc voltage is user-defined according to whether it is required to maximise brightness or contrast ratio of an image displayed by the apparatus.

8. Apparatus according to claim 7, comprising selection means to enable a user to select whether to maximise brightness or contrast ratio of an image displayed by the apparatus.

9. Apparatus according to claim 1, wherein said fluid is coloured.

10. Apparatus according to claim 9, comprising a single charged particle in said coloured fluid.

11. A method of increasing brightness or contrast ratio in a display apparatus comprising:
An electrophoretic medium (5) comprising charged particles (6) in a fluid;
A plurality of picture elements (2);
A first and second electrode (3,4) associated with each picture element (2) for receiving a potential difference; and
Drive means arranged to supply a sequence of picture potential differences to each of said picture elements (2) so as to cause said charged particles (6) to move and change the optical state of a respective picture element (2) substantially continuously between two extreme grey scales according to an image to be displayed;
wherein the method comprises supplying picture potential differences which have a non-zero average dc value, the polarity of which is selected to increase the level of brightness of one said extreme grey scales or to increase the contrast ratio of the image displayed by said apparatus.

12. Drive means for driving a display apparatus (1) comprising:
An electrophoretic medium (6) comprising charged particles (6) in a fluid;
A plurality of picture elements (2); and
A first and second electrode (3,4) associated with each picture element (2) for receiving a potential difference;
Drive means being arranged to supply a sequence of picture potential differences to each of said picture elements (2) so as to cause said charged particles (6) to move and change the optical state of the respective picture elements (2) substantially continuously between two extreme grey scales according to an image to be displayed,
wherein said picture potential differences have a non-zero average DC value, the polarity of which is selected to increase the level of brightness of one of said extreme grey scales or to increase the contrast ratio of the image displayed by said apparatus (1).

13. A drive waveform for driving a display apparatus (1) comprising:
An electrophoretic medium comprising charge particles (6) in a fluid;
A plurality of picture elements (2);
A first and second electrode (3,4) associated with each picture element (2) for receiving a potential difference; and
Drive means arranged to supply said drive waveform to said apparatus, said drive waveform comprising a sequence of picture potential differences for application to each of said picture elements (2) so as to cause said charged particles (6) to move and change the optical state of a respective picture element (2) substantially continuously between two extreme grey scales according to an image to be displayed, wherein said picture potential differences have a non-zero average DC value, the polarity of which is selected to increase the level of brightness of one of said extreme grey scales or to increase the contrast ratio of the image displayed by said apparatus.
